(19) United States
(12) Patent Application Publication
(10) Pub. No.: US 2006/0008029 A1
(43) Pub. Date: Jan. 12, 2006

(54) Transmitter stage

(76) Inventors: Houman Jafari, Erlangen (DE); Ralf Burdenski, Nurnberg (DE); Gerald Ulbricht, Rothenbach (DE)

Correspondence Address: GARDNER GROFF, P.C., 2018 POWERS FERRY ROAD, SUITE 800, ATLANTA, GA, 30339, US

(21) Appl. No.: 11/155,838

(22) Filed: Jun. 17, 2005

Related U.S. Application Data
(63) Continuation of application No. PCT/EP03/12736, filed on Nov. 14, 2003.

(30) Foreign Application Priority Data
Dec. 18, 2002 (DE) 102 59 356.6-35

(51) Int. Cl. H04K 1/02

(52) U.S. Cl. 375/297

(57) ABSTRACT

A transmitter stage working according to the envelope restoration principle includes means for providing an amplitude representation and a phase representation of an amplitude and phase-modulated signal to be transmitted, as well as a phase-locked loop with a feed-forward branch and a feedback branch, as well as amplification control means formed to convert the amplitude representation to an amplification control signal, which may be fed into the amplification control input of a nonlinear power amplifier. In the feed-forward branch, a digital/analog converter is arranged. Furthermore, in the feedback branch, an analog/digital converter is arranged, so that the phase detector of the phase-locked loop is implemented in digital form. By an as large as possible proportion of digital signal processing, an inexpensively implementable and exactly working transmitter stage is obtained.

### CROSS-REFERENCE TO RELATED APPLICATION

This application is a continuation of co-pending International Application No. PCT/EP03/12736, filed Nov. 14, 2003, which designated the United States and was not published in English and is incorporated herein by reference in its entirety.

### BACKGROUND OF THE INVENTION

1. Field of the Invention

The present invention relates to transmitter stages, and in particular to transmitter stages being able to send a phase and amplitude-modulated signal via an amplifier operated in the nonlinear range, according to the EDGE or UMTS specification.

2. Description of the Related Art

For mobile communication services, only a limited amount of frequency bands exist. The required channel bandwidth in the data transmission and the possible data rate are critical factors, which characterize the effectiveness of a transmission system. Within a frequency band, a maximum data rate is strived for. There are various methods permitting to allow for higher data rate at equal channel bandwidth and thereby enable more efficient message flow.

In the past few years the GSM (Global System for Mobile Communication) standard has become established in the field of mobile communication. Here, GMSK (Gaussian Minimum Shift Keying) modulation is used. The GMSK is among the so-called CPM (Continuous Phase Modulation) modulation methods. These are nonlinear digital modulation methods with constant amplitude and steady phase.

The increase of the message flow may take place by change of the modulation method. Here, instead of a GMSK modulation, 3n/8-8PSK (Phase Shift Keying) modulation is used for the GSM-EDGE (Enhancement Data Ratio for GSM Evaluation) standard, or QPSK (Quadrature Phase Shift Keying) modulation for UMTS (Universal Mobile Telecommunications System) standard. The 3n/8-8PSK modulation and the QPSK modulation also contain an amplitude component apart from the phase modulation. Thereby, transmission: of additional information is possible for an increase in the data rate at equal channel bandwidth.

A critical point in the mobile terminal is the transmission behavior of the RF transmission amplifier with reference to the RF signals to be transmitted for the EDGE and UMTS standards. In contrast to the GMSK modulation, the phase and the amplitude are modulated in the 3n/8-8PSK modulation and QPSK modulation. The result is spectral broadening of the output signal after the nonlinear power amplifier and noticeable distortion of the transmission signal, respectively. This leads to an increase in the bit error rate (BER) at equal reception field strength.

In order to minimize these distortions, the use of a linear power amplifier would actually be required. The efficiency of linear amplifiers, in comparison with nonlinear power amplifiers, which achieve an efficiency of about 50% to 60%, is, however, much worse at about 35%.

The high energy consumption of the system by the lower efficiency of the components is in contrast to the desire to achieve as-long-as-possible operation times of the mobile station.

Signal reconstruction techniques, such as polar loop, enable the use of nonlinear power amplifiers also for the EDGE standard and UMTS standard.

So-called polar loop transmission circuits are described in U.S. Pat. No. 4,481,672, WO 02/47249 A2, U.S. Pat. No. 4,630,315, or GB 2368214 A, for example.

EP 1211801 A2 also discloses a polar loop transmission circuit suitable for future mobile radio systems having phase and amplitude modulation and may also be used for known systems according to the GSM standard. The polar loop transmission circuit includes a power amplifier receiving a signal from a VCO on the input side. The control signal for the VCO is acquired by amplitude limiting the transmission signal as target signal and by amplitude limiting an actual signal, subsequent phase comparison of the limited signals and subsequent low-pass filtering.

The amplitude control signal for the controllable nonlinear power amplifier is generated by envelope detection of the transmission signal as target signal, envelope detection of an actual signal, subsequent difference formation by means of a differential amplifier, and subsequent low-pass filtering.

The actual signal for the amplitude regulation as well as for the phase regulation is tapped off from the output of the nonlinear power amplifier, fed to a programmable amplifier, then mixed down to an intermediate frequency, fed to a ramp-like controllable amplifier, and then fed into the rectifier for amplitude regulation on the one hand and into the limiter for phase regulation on the other hand.

At the control terminal of the programmable amplifier, into which a feedback signal tapped off from the output is at first fed, the power level may be regulated with a control signal at the output of the polar loop transmission circuit. Here, the programmable amplifier is a linear amplifier, which linearly attenuates the signal that may be fed at its input. But the voltage of the radio frequency signal provided at its output is not linearly dependent on an adjusting signal that may be fed at the control terminal, and is, for example, 2 dB per least significant bit change of the adjusting signal.

Typical polar loop transmission circuits, as they are disclosed in EP 1211801 A2, are suited for cellular radio telephones according to the GSM standard, as well as for alternative modulation methods, in which phase and amplitude modulations have to take place.

As a further component, such cellular mobile radio systems have automatic amplification regulation in that a field strength measurement is performed in the base station and/or in the mobile part in order to regulate the transmission power of the mobile telephone and/or the base station up, when it is ascertained that the current transmission channel is not satisfactory, due to low reception field strength.

On the one hand, it is desirable, in the interest of a low bit error rate, to use very high transmission power, because with this the signal/noise ratio at the receiver, and thus the bit error rate, automatically drops. On the other hand, high transmission power is not desired due to increasing resistance among the people. Furthermore, high transmission power leads to the fact that the cells can only be designed in relatively rough-meshed manner, or that a carrier frequency cannot be “reused” as often as possible in a cell raster in order to allow for a high participant number in the limited frequency band.

Particularly, when using nonlinear amplifiers, high transmission power has the problem that side channel interferences may increase, i.e. that a transmitter actually specified for one carrier frequency also transmits power, due to its non-linearity, in a side channel in which it actually should not be allowed to send at all or only below a threshold. Such a transmission device is not according to requirements when the so-called side channel transmission lies above a certain specification. For example, for the EDGE standard mentioned, it is required that the spectrum of the output signal of the radio device is smaller than −54 dBc at an offset frequency of +/−200 kHz with reference to a carrier frequency, and further lies below −60 dBc at an offset frequency of +/−300 kHz with reference to the carrier.

For the UMTS standard it is required that the spectrum of the output signal is better than −45 dBc in the entire side channel.

All these requirements lead to a conclusion that the transmission power of the mobile telephone has to be as low as possible, when thinking of GSM and EDGE.

With UMTS, however, a broad-band CDMA technology is used. There is the requirement that the signals of the mobile telephones communicating with a base station have about equal power at the base station. For this reason, very quick power regulation is performed in the mobile telephones.

Furthermore, especially for mobile telephones, there is the requirement that they have to be inexpensive, because the mobile telephone market has become an extremely competitive market, in which already small price advantages have lead to the fact that the one system survived, i.e. was accepted by the market, whereas the other system has not been successful on the market.

For mobile telephones, therefore, transmission power regulation as sensitive as possible is employed, which reduces the power very quickly and as far as possible in the case of a good transmission channel, which is, however, also capable of increasing the transmission power very quickly and particular very strongly in the case of a, in most cases only for a short time, bad channel. A polar loop transmission circuit thus has to work in a very high dynamic range of the power amplifier on the one hand and cope with a very high dynamic range with respect to the amplitude-locked loop and phase-locked loop together forming the polar loop on the other hand.

Disadvantages in the concept disclosed in EP 1211801 A2 consist in that the adjustment of the output power takes place by the programming of the programmable amplifier in the feedback branch. The programmable and the downstream ramp-like operable amplifier thus have to provide an output signal with very high dynamics, which is very small in one case, i.e. at maximum output transmission power, and which is very large in the other case, i.e. at minimum output power, and here particularly comes into the proximity of the amplitude of the output signal from the transmission signal generator.

It has been found out that the intensive polar loop concept including a complete phase-locked loop and in addition a complete amplitude-locked loop is not mandatory to be employed in all cases. It has turned out that for many applications circuits on the basis of the ER (Envelope Restoration) concept are sufficient. Transmission circuits according to the ER principle have, just like polar loop circuits, a phase-locked loop, but do not include an amplitude-locked loop in contrast to polar loop circuits, but control the amplitude on the basis of the amplitude modulation component of the signal to be transmitted, without feedback having to take place.

Transmitter stages without amplitude-locked loop (ALL) are known from U.S. Pat. No. 6,256,482.

In general, in transmitter stages used for cellular mobile radio, there is the requirement that they have to meet the narrow specifications and at the same time have to be inexpensive, i.e. can be implemented with minimum circuit overhead. This is due to the fact that, in particular, in the mobile telephone market, the requirements for a low price are very significant, because meanwhile it has become commonplace that a customer, when signing a contract with a network provider, only pays a small amount or even nothing at all for his or her mobile telephone. Inexpensively manufactured mobile telephones are therefore crucial for the profit margin of the network operator, since they have to “give away”, so to speak, the mobile telephone together with a contract.

### SUMMARY OF THE INVENTION

It is an object of the present invention to provide a precisely working and at the same time inexpensive implementable transmitter stage.

In accordance with a first aspect, the present invention provides a transmitter stage for transmitting an amplitude and phase-modulated signal using a power amplifier with a signal input, a signal output, and an amplification control input, having: a provider for providing an amplitude representation and a phase representation of the amplitude and phase-modulated signal; a phase-locked loop with a feed-forward branch and a feedback branch, wherein the feed-forward branch has a phase detector for comparing the phase representation as target signal with an actual signal to provide a tuning signal, a loop filter, and a controllable oscillator, which may be coupled to the signal input of the power amplifier, wherein the feedback branch is coupled to a diverter for diverting a signal at the signal output of the power amplifier and has a determinator for determining the actual signal; and an amplification controller formed to convert the amplitude representation to an amplification control signal, which may be fed into the amplification control input of the power amplifier, wherein a digital/analog converter is provided in the feed-forward branch in signal flow direction upstream of the controllable oscillator, wherein an analog/digital converter is provided in the feedback branch in signal flow direction upstream of the phase detector and downstream of the diverter, wherein the phase detector is implemented as digital phase detector, and wherein the provider is formed to provide the phase representation in digital form.

In accordance with a second aspect, the present invention provides a transmitter stage for transmitting an amplitude and phase-modulated signal using a power amplifier with a signal input, a signal output, and an amplification control input, having: a provider for providing an amplitude representation and a phase representation of the amplitude and phase-modulated signal; a phase-locked loop with a feed-forward branch and a feedback branch, wherein the feed-forward branch has a phase detector for comparing the phase representation as target signal with an actual signal to provide a tuning signal, a loop filter, and a controllable oscillator, which may be coupled to the signal input of the power amplifier, wherein the feedback branch is coupled to a diverter for diverting a signal at the signal output of the power amplifier and has a determinator for determining the actual signal; and an amplification controller formed to convert the amplitude representation to an amplification control signal, which may be fed into the amplification control input of the power amplifier, wherein a digital/analog converter is provided in the amplification controller, so that an analog amplification control signal may be fed into the amplification control input of the power amplifier, and wherein the provider is formed to provide the amplitude representation in digital form.

In accordance with a third aspect, the present invention provides a method of transmitting an amplitude and phase-modulated signal using a power amplifier with a signal input, a signal output, and an amplification control input, with the steps of: providing an amplitude representation and a phase representation of the amplitude and phase-modulated signal; comparing the phase representation as target signal with a phase actual signal to obtain a tuning signal for a controllable oscillator, which may be coupled to the signal input of the power amplifier; calculating the phase actual signal by diverting a signal at the signal output of the power amplifier and converting the diverted signal to the phase actual signal; and determining an amplification control signal from the amplitude representation and feeding the amplification control signal into the amplification control input of the power amplifier, wherein the step of determining the tuning signal includes a step of digital/analog converting, wherein the step of determining the actual signal includes a step of analog/digital converting, wherein, in the step of comparing, digital signals are compared, and wherein, in the step of providing, the phase representation of the amplitude and phase-modulated signal is provided in digital form.

In accordance with a fourth aspect, the present invention provides a computer program with a program code for performing, when the program is executed on a computer, the method of transmitting an amplitude and phase-modulated signal using a power amplifier with a signal input, a signal output, and an amplification control input, with the steps of: providing an amplitude representation and a phase representation of the amplitude and phase-modulated signal; comparing the phase-representation as target signal with a phase actual signal to obtain a tuning signal for a controllable oscillator, which may be coupled to the signal input of the power amplifier; calculating the phase actual signal by diverting a signal at the signal output of the power amplifier and converting the diverted signal to the phase actual signal; and determining an amplification control signal from the amplitude representation and feeding the amplification control signal into the amplification control input of the power amplifier, wherein the step of determining the tuning signal includes a step of digital/analog converting, wherein the step of determining the actual signal includes a step of analog/digital converting, wherein, in the step of comparing, digital signals are compared, and wherein, in the step of providing, the phase representation of the amplitude and phase-modulated signal is provided in digital form.

The present invention is based on the finding that inexpensive transmitter stages can be implemented, which only have a phase-locked loop, but which perform amplitude modulation of a signal output from a power amplifier directly according to the envelope restoration principle, i.e. without feedback.

The phase-locked loop consists of a feed-forward branch and a feedback branch, and includes a phase detector for comparing a phase representation as target signal with an actual signal, in order to provide a tuning signal, which is filtered in a loop filter and fed to a controllable oscillator, which may in turn be coupled to the signal input of the power amplifier.

According to a first aspect of the present invention, a digital/analog converter is provided in the feed-forward branch in signal flow direction upstream of the controllable oscillator and downstream of the phase detector. Furthermore, an analog/digital converter is provided in the feedback branch in signal flow direction upstream of the phase detector and downstream of diverting means diverting part of the power amplifier output signal for feedback, so that the phase detector is embodied as digital phase detector. This has the advantage that as such expensive analog phase detector circuits, as they are used in polar loop circuits, are no longer required in the inventive concept.

Particularly for EDGE or UMTS applications, the base band modulation signals are present digitally anyway, so that the inventive concept enables as great as possible signal processing in the digital domain, wherein it is proceeded to the analog domain as late as possible, for which the expensive analog devices are required, which are expensive not only regarding their own manufacturing costs, but also intensive in assembly and calibration and are opposed to the concept of as advanced as possible integrability.

According to the present invention, a significant part of the transmitter stage may be embodied in completely integrated manner in a digital signal processor (DSP), which on the one hand enables mass production and on the other hand leads to deviations from DSP to DSP, i.e. from mobile telephone to mobile telephone, becoming minimal.

According to another aspect of the present invention, in the amplification control means formed to convert the amplitude representation of the signal to be transmitted to an amplification control signal, a digital/analog converter is provided, turning the amplitude representation signal normally present digitally into an analog signal, which can be coupled into the amplification control input of the power amplifier.

In a preferred embodiment of the present invention, the amplification control means includes a variable gain amplifier, via which the output level of the power amplifier is controllable over a high dynamic range. The control input of the variable gain amplifier is addressed by channel measuring means to adjust the transmission power at the receiver of the base station as desired.

The amplifier is arranged upstream of the digital/analog converter and may thus be completely embodied as digital amplifier. Digital signals supplied from a channel determination means of the base station (or alternatively also of the mobile telephone) may thus be fed into the transmitter stage, and the digital amplifier may implement flexibly selectable transfer functions due to its digital nature.

In a preferred embodiment of the present invention, a down-converter is present in the feedback branch, in order to convert the diverted signal present at a transmission frequency to an easily governable intermediate frequency, wherein the signal present in its frequency at the intermediate frequency is then analog/digital converted to then be processed further digitally, in order to finally be fed to the phase detector in the feed-forward branch. In a further preferred embodiment of the present invention, upstream of the frequency converter, an attenuator with variable attenuation is connected, which is operated correspondingly to the variable gain amplifier in the amplification control means, in order to provide a signal with constant power or with a power in a well-defined predetermined range independently of the output power of the power amplifier, so that it is ensured that neither the mixer nor the downstream analog/digital converter are over-modulated.

The present invention is advantageous in particular in that on the one hand no quick and on the other hand no expensive analog/digital converters with high dynamics are required in the phase-locked loops, because all digital/analog converters work in a comfortably governable frequency range on the one hand and process input signals having an a priori known power level constant within a tolerance on the other hand.

A further advantage of the present invention is that the shift of the digital interface to the front is shifted up to a preferably provided anti-aliasing filter (AAF), so that a maximum part of the transmitter stage is embodied digitally and may thus be implemented integrated in a digital signal processor.

With employment of the variable attenuator in the feedback branch, amplitude stabilization of the returned signal is achieved to prevent over-modulation of the analog/digital converter in the feedback branch.

A further advantage of the present invention is that the I/Q signal of an EDGE or UMSTS signal source is processed in completely digital manner into amplitude information A(t) and phase information φ(t). Thereby, use of limiter circuits and amplitude demodulators like in the polar loop concept becomes superfluous.

Moreover, the present invention is advantageous in that preferably digital frequency conversion of the phase information is used. Hereby, sufficient adjustment of the bandwidth of the PLL loop is guaranteed. In particular, it is preferred to embody both the loop filter of the PLL and the low-pass filter connected downstream of a variable amplifier in the amplification control means in digital manner, so that simple and flexible adjustment of the filter coefficients of the digital filter is possible to realize arbitrarily desired transfer functions.

A further advantage of the present invention is that AM/PM distortions of the nonlinear power amplifier are corrected by the PLL.

Furthermore, the present invention is advantageous in that it provides high precision by employing completely digital signal processing for the substantial parts of the locked loop as well as for the substantial part of the amplification control means for amplitude variation of the power amplifier.

Furthermore, the present invention provides the possibility of precise controllability of filter characteristics and the possibility of the adaptation to component characteristics, e.g. of the power amplifier and the VCO simply via software adjustments of the filter coefficients of a FIR or IIR filter.

Due to the significant proportion of digital signal processing, the inventive transmitter stage can be implemented inexpensively on the one hand and is precise enough on the other hand to meet specifications given by modern mobile radio standards.

### BRIEF DESCRIPTION OF THE DRAWINGS

These and other objects and features of the present invention will become clear from the following description taken in conjunction with the accompanying drawings, in which:

FIG. 1 is a block circuit diagram of an inventive transmitter stage;

FIG. 2 is a block circuit diagram of an inventive transmitter stage according to a preferred embodiment;

FIG. 3 is a tabular representation of the connection of the control of the variable attenuator and the variable amplifier; and

FIG. 4 is a comparison of the VCO output spectrum and the power amplifier output spectrum.

### DESCRIPTION OF THE PREFERRED EMBODIMENTS

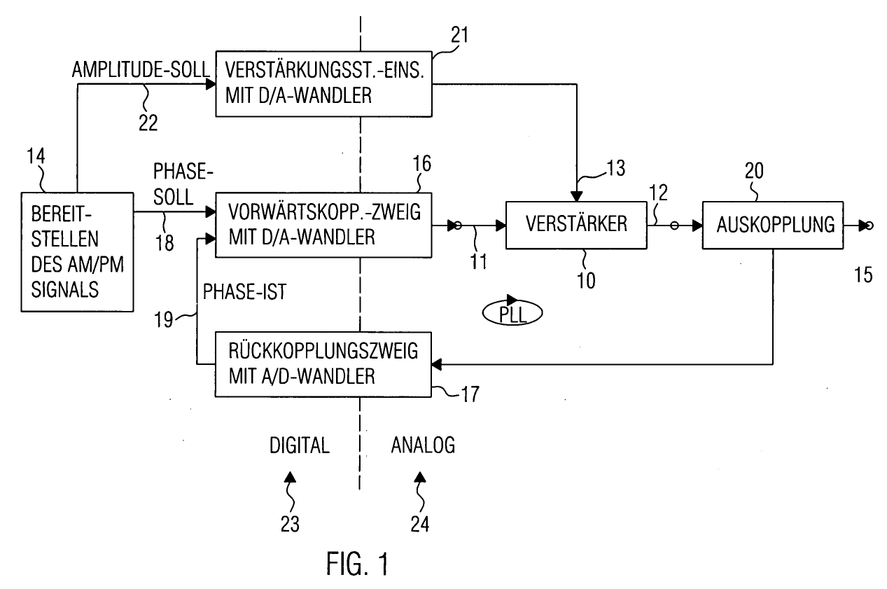

FIG. 1 shows a block circuit diagram of an inventive transmitter stage for transmitting an amplitude and phase-modulated signal using a power amplifier 10 with a signal input 11, a signal output 12, and an amplification control input 13.

The transmitter stage includes means 14 for providing the amplitude and phase-modulated signal, which is designated with 14 in FIG. 1. Means 14 is operable to generate the signal, which is finally output from the amplifier 10 and is to be radiated e.g. at an antenna, which can be coupled at an overall output 15 of the circuit.

The transmitter stage shown in FIG. 1 further includes a phase-locked loop (PLL) with a feed-forward branch 16 and a feedback branch 17. The feed-forward branch 16 includes a phase detector for comparing the phase representation supplied by means 14 as phase target signal 18 with a phase actual signal 19, in order to provide a tuning signal filtered by a loop filter and fed to a controllable oscillator, which may be coupled to the signal input 11 of the power amplifier.

The feedback branch 17 is coupled to diverting means 20, which is formed to divert a signal at the signal output 12 of the power amplifier 10 and feed it to the feedback branch 17. The feedback branch further includes means for determining the phase actual signal 19 from the diverted signal supplied from the diverting means 20.

The inventive transmitter stage of FIG. 1 further includes amplification control means 21, which is formed to convert the amplitude representation, i.e. the amplitude target signal 22 supplied by means 14, to an amplification control signal, which may be fed into the amplification control input 13 of the power amplifier 10.

According to the invention, a digital/analog converter is provided in the feed-forward branch 16 in signal flow direction upstream of the controllable oscillator and downstream of the phase detector. Furthermore, an analog/digital converter is provided in the feedback branch 17 in signal flow direction downstream of the diverting means, such that the phase detector in the feed-forward branch 16 is embodied as digital phase detector. Means 14 for providing the AM/PM signal, i.e. the amplitude target signal 22 and the phase target signal 18, is implemented in the embodiment according to the first aspect of the present invention such that at least the phase target signal is provided as digital signal.

According to another aspect of the present invention, means 14 is formed to provide at least the amplitude target signal 22 as digital signal. In this case, a digital/analog converter is provided in the amplification control means 21, so that a digital amplitude target signal 22 can be supplied by means 14 for providing the AM/PM signal, and on the other hand an analog signal can be fed into the amplification control input 13 of the power amplifier 10.

According to a further aspect of the present invention, means 14 for providing the AM/PM signal is formed to provide both a digital phase target signal 18 and a digital amplitude target signal 22, such that both a digital/analog converter is provided in the amplification control means 21 and digital/analog and analog/digital conversion is performed in the feed-forward branch 16 and in the feedback branch 17, respectively, such that the entire inventive transmitter stage, as it is shown in FIG. 1, can be divided into a digital domain 23 and an analog domain 24 with an intervening A/D interface and D/A interface, respectively.

In a preferred embodiment of the present invention, the entire digital area, i.e. all signal processings upstream of the digital/analog converters or analog/digital converters is integrated in a digital signal processor, such that as much signal processing as possible is executed on digital side, i.e. implementable in exact and inexpensive manner.

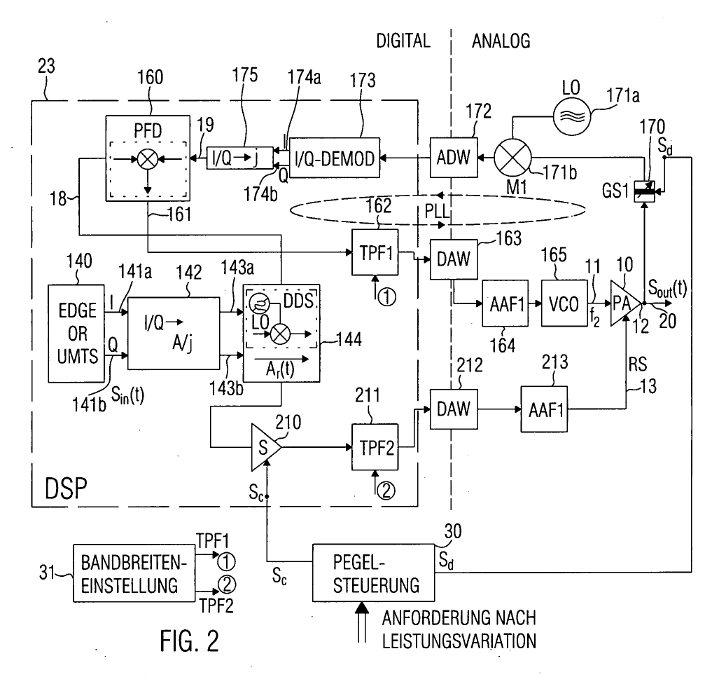

FIG. 2 shows a block circuit diagram of a transmitter stage according to a preferred embodiment of the present invention, in which an outlined part 23 represents the digital domain and is embodied as DSP (digital signal processor).

The feed-forward branch 16 of FIG. 1 in FIG. 2 includes a phase and/or frequency detector 160 receiving the phase target signal 18 and the phase actual signal 19 and providing a tuning signal 161 at the output side, which is filtered in a low-pass filter 162 according to predetermined loop characteristics. The output signal of the low-pass filter 162 is fed to a digital/analog converter 163, which is connected to a correspondingly adjusted anti-aliasing filter 164 on the output side, in order to suppress aliasing interferences introduced by the operations performed in the DAC 163.

The anti-aliasing filter 164 is connected on the output side to a controllable oscillator 165, which is a voltage-controlled oscillator in the preferred embodiment of the present invention shown in FIG. 2. On the output side, the VCO 165 provides the signal present at a frequency f₂, which now carries the phase information of the phase target signal 18 as phase modulation. The VCO 165 is further operable to convert a phase target signal 18 present at an intermediate frequency f₁ to the transmission frequency f₂, which will typically be in the range of 900 MHz, 1.8 GHz or 2.1 GHz, etc.

In the preferred embodiment of the present invention shown in FIG. 2, the feedback branch 17 includes a controllable attenuator 170, a frequency converter with a local oscillator 171a, and a mixer 171b, in order to convert the fed-back signal present at the RF frequency to an intermediate frequency f₁, which is easier to process. The signal at the output of the mixer 171b present at the IF is fed into an analog/digital converter 172, which again represents the interface between the analog domain and the digital domain. The digital output signal of the analog/digital converter 172 is supplied to an IQ demodulator 173 performing IQ demodulation, in order to obtain an I component 174a and a Q component 174b at the output side. The I/Q components are fed to a converter 175, which is formed to convert I and Q to a phase representation as will be explained later on.

At the output of the I/Q-φ converter 175, then the phase actual signal 19 of FIG. 1 is present, which is fed into the actual signal input of the phase detector 160.

Means 14 for providing the AM/PM signal of FIG. 1 includes, in the preferred embodiment shown in FIG. 2, an EDGE or UMTS signal generator 140, which provides an I signal 141a and a Q signal 141b, which are together also designated as input signal Sᵢₙ(t). I and Q are present in the base band and represent time-dependent information signals converted to a base band amplitude modulation signal 143b and a base band phase modulation signal 143a by an I/Q-A/φ converter 142. The signals 143a and 143b are fed to a digital frequency converter 144, which is also referred to as DDS (Directed Digital Synthesizer) in FIG. 2. The digital mixer 144 may be embodied according to arbitrary digital algorithms to convert the phase information 143a, i.e. the time-dependent base band phase representation, to a phase representation of the phase-modulated signal at the intermediate frequency f₁, wherein this signal is referred to as phase target signal 18 in the embodiment shown in FIG. 2.

The mixer 144 is further operable, regarding the amplitude representation, to output same unchanged or possibly conditioned somehow, i.e. amplified, attenuated, etc., namely as amplitude target signal 22, which is fed into the amplification means 21 of FIG. 1. In the preferred embodiment of the present invention shown in FIG. 2, the amplification means 21 includes a variable amplifier 210, a downstream low-pass filter 211, a digital/analog converter 212, as well as an anti-aliasing filter 213 downstream of the DAC 212, which is also referred to as AAF2 in FIG. 2. The components mentioned are effectively coupled to each other in such a way, as it can be seen from FIG. 2. At the output of the anti-aliasing filter 213, then the amplification control signal 13 is present, via which the level of the output signal Sₒᵤₜ(t) is controllable. For level control, the transmitter stage shown in FIG. 2 further includes a level control unit 30, which on the one hand controls the variable gain amplifier 210 via the control signal s_{c}, in order to achieve a higher signal level at the output 12 of the amplifier 10. In order to ensure at the same time that the analog/digital converter 172 in the feedback branch is not over-modulated, the level control means 30 further controls the variable attenuation of the attenuator 170 via a control signal s_{d}.

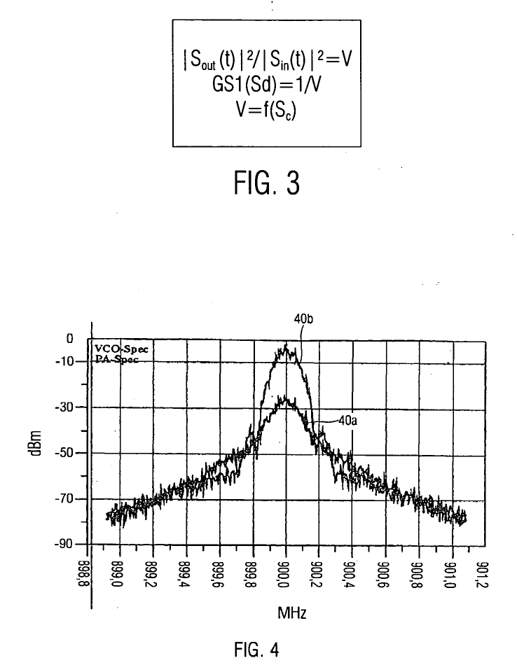

For this, the connections shown in FIG. 3 are used. In particular, the ratio between the magnitude square of Sₒᵤₜ₍ₜ₎ at the output of the transmitter stage and the magnitude square of Sᵢₙ(t) at the output of the signal generator 140 is designated as amplification V. The attenuation of the variable attenuator is adjusted in inverse proportion to V, namely via the signal s_{d}. Furthermore, the amplification of the entire transmitter stage is a function of the control signal for the variable gain amplifier 210, this signal being referred to as s_{c}.

The transmitter stage shown in FIG. 2 according to a preferred embodiment of the present invention further includes a bandwidth adjustment means 31 formed to provide correspondingly desired filter coefficients to the low-pass filters 162 and 211. An advantage of the present invention exactly consists in the fact that the low-pass filters 162 and 211, and in particular the low-pass filter 162, which determines substantial characteristics of the PLL, may be implemented digitally and thus also be adjusted digitally variably and easily in software depending on demand, wherein adjusting a filter characteristic of a digital filter can be done substantially more easily and above all more inexpensively than adjusting the characteristics of an analog low-pass filter.

FIG. 4 shows a comparison of two spectrums of the circuit shown in FIG. 2. The spectrum with lower power 40a is the spectrum at the output of the VCO 165, i.e. the signal input into the signal input 11 of the power amplifier 10. The other spectrum with higher power is a spectrum obtained at the output 12 of the power amplifier 10. This spectrum is designated with 40b in FIG. 4. From FIG. 4, it is obvious that the spectrum 40b of the power amplifier 10 has sufficient selectivity in that the UMTS and EDGE specifications regarding the side channel transmission are met. Moreover, the dynamic range of the power amplifier output signal is in the range of 60 dB. Furthermore, it can be seen from FIG. 4 that the bandwidth of the power amplifier spectrum is held within the bandwidth of the VCO output signal by the PLL and is in parts, toward higher offset frequencies, even better than the output spectrum of the VCO 165.

The inventive concept is based on the ER technology. Here, the PLL is a substantial part of the transmitter stage. The I/Q signal of an EDGE or UMTS signal source 140 is converted to digital amplitude information A(t) and digital phase information φ(t) in the digital converter 142. As it is known, amplitude information is calculated from an I component and a Q component as follows:
A(t)=(I(t)²+Q(t)²)^{1/2}
For the phase information φ(t), the following equation results:
φ(t)=arctan(Q(t)/I(t))
The output signal s₁(t) generated by means 142 may thus be represented as follows:
s₁(t)=A(t)·cos(ω₁t+φ(t)).
The phase information φ(t) is “modulated onto” the carrier frequency s₁ in the element 144.

The output signal Sₒᵤₜ(t) at the output of the circuit is attenuated in the regulatable attenuator 170. The attenuated signal s₂(t) is converted to the frequency f*₁ in the mixer 171b. The signal is then digitized in the analog/digital converter 172 and then mapped as I(t) and Q(t) signals in the digital domain 23 in the block IQ demodulator 173.

The phase φ₂(t)=f(I(t), Q(t)) calculated from I(t) and Q(t), wherein an arctangent function is preferred as function f, is fed to the phase frequency detector 160. In the phase frequency detector, a comparison between the input signal φ*₁(t), which is the phase target signal 18, with the converted part of the output signal φ₂(t) takes place. The error signal, which is also referred to as “tune”, is filtered via a loop filter 162 with low-pass character and then converted to an analog representation in the digital/analog converter 162 and filtered by an anti-aliasing filter 164. The filtered signal is then fed to the voltage-controlled oscillator 165 as tuning signal. The signal thus generated corrects the VCO with a center frequency of f₂ corresponding to the tune signal in frequency and phase. The PLL provides that the phase differences developing due to AM/PM distortions in the power amplifier are corrected.

The envelope of the modulated signal, i.e. the AM portion, is fed to the nonlinear power amplifier (PA) via the modulation of, for example, the operating voltage. For this, the amplitude information derived from the signals I(t) and Q(t) in the digital converter 142 is amplified in the controllable amplifier 210. The amplified signal is then guided via the loop filter 211 with low-pass character. The filtered signal is then converted in the digital/analog converter 212 and filtered by a subsequent anti-aliasing filter 213 in order to be fed to the nonlinear power amplifier 10 as amplitude regulation voltage.

The output power of the transmission amplifier 10 may be adjusted with the control value f_{c} via the controllable amplifier 210 according to demand. The controllable attenuator 170 is adjusted by the control value s_{d} depending on the output power of the transmission amplifier 10. This provides for the returned signal always having the same signal level after the mixer 171b. In other words, amplitude stabilization of the fed-back signal s₂(t) is performed. At this point it is to be pointed out that it is preferred for the signal at the input of the ADC 172 always to have the same constant power level. Depending on implementation of the components, it may however already be sufficient that the signal lies in a predetermined range extending for example by +/−10% around a target level value. Hereby, over-modulation of the analog/digital converter 172 is prevented even at great output powers. Of course, the diverting means 20 may be implemented together with the attenuator 170 as variable directional coupler or something similar.

The amplifier 10 is amplitude-modulated via a supply voltage variation. There is not necessarily a linear connection between the control signal (RS) and the output power. A table may have a list of amplification control input signals, with a supply voltage stage for the transistor being associated with each input signal. By exchange or reprogramming of the table, the transmitter stage may thus be easily adapted to other amplifiers.

In FIG. 4, the spectrums of the phase-modulated signal 40a after the VCO and of the amplitude and phase-modulated signal 40b after the power amplifier are illustrated. It can be seen such a spectrum after the power amplifier achieved dynamics better than 60 dB. This is necessary to achieve the specifications for the EDGE standard.

Although the inventive concept of the division into digital domain and analog domain has previously been described on the basis of the envelope reconstruction technique, it is pointed out that this concept can also be used for the polar loop technique. With reference to FIG. 2, a modification of the amplification control means 21 of FIG. 1 would consist in, for example, calculating actual amplitude information from the output signal of the IQ demodulator 173 in the feedback branch, for example by sample-wise squaring of I and Q, by summation of the squares and by ensuing root extraction, in order to obtain the actual amplitude information as function of the time. The actual amplitude information would then be compared with the actual amplitude information at the output of the DDC 144 to obtain a comparison signal fed into the amplifier 210 in FIG. 2 instead of the target amplitude information. The amplification control means would therefore be operable to convert to the amplitude representation supplied by means 14 of FIG. 1 to an amplification control signal derived from the comparison result, taking a comparison with actual amplitude information from the feedback branch into account.

Depending on the conditions, the inventive method of transmitting can be implemented in hardware or in software. The implementation may be on a digital storage medium, in particular a floppy disc or CD with electronically readable control signals, which may interact with a programmable computer system so that the inventive method of transmitting is executed. In general, the invention thus also consists in a computer program product with a program code stored on a machine-readable carrier for the execution of the inventive method, when the computer program product is executed on a computer. In other words, the invention may thus also be realized as a computer program with a program code for the execution of the method, when the computer program is executed on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A transmitter stage for transmitting an amplitude and phase-modulated signal using a power amplifier with a signal input, a signal output, and an amplification control input, comprising:
a provider for providing an amplitude representation and a phase representation of the amplitude and phase-modulated signal;
a phase-locked loop with a feed-forward branch and a feedback branch,
wherein the feed-forward branch comprises a phase detector for comparing the phase representation as target signal with an actual signal to provide a tuning signal, a loop filter, and a controllable oscillator, which may be coupled to the signal input of the power amplifier,
wherein the feedback branch is coupled to a diverter for diverting a signal at the signal output of the power amplifier and comprises a determinator for determining the actual signal; and
an amplification controller formed to convert the amplitude representation to an amplification control signal, which may be fed into the amplification control input of the power amplifier,
wherein a digital/analog converter is provided in the feed-forward branch in signal flow direction upstream of the controllable oscillator,
wherein an analog/digital converter is provided in the feedback branch in signal flow direction upstream of the phase detector and downstream of the diverter,
wherein the phase detector is implemented as digital phase detector, and
wherein the provider is formed to provide the phase representation in digital form.

2. The transmitter stage of claim 1, wherein the phase detector is a digital phase/frequency detector.

3. The transmitter stage of claim 1, wherein the provider comprises:
a digital IQ generator for providing a time-dependent I signal and a time-dependent Q signal, and
a digital converter for converting the time-dependent I signal and the time-dependent Q signal to a digital time-dependent amplitude representation and to a digital time-dependent phase representation.

4. The transmitter stage of claim 3, wherein the IQ generator is an EDGE or UMTS generator.

5. The transmitter stage of one claim 1, wherein the provider further comprises a digital mixer to convert a digital time-dependent phase representation to an intermediate frequency.

6. The transmitter stage of claim 1,
wherein the feedback branch comprises an analog mixer to convert the diverted signal from a transmission frequency to an intermediate frequency, and
wherein the analog/digital converter is arranged downstream of the analog mixer in terms of signal flow.

7. The transmitter stage of claim 1,
wherein a digital IQ demodulator for IQ demodulating is further provided downstream of the analog/digital converter in the feedback branch in terms of signal flow, in order to obtain an I component and a Q component, and wherein a converter for converting the I component and the Q component to a digital phase representation as actual signal is also arranged.

8. The transmitter stage of claim 1, wherein the feedback branch further comprises a controllable attenuator between the analog/digital converter and the diverter, wherein the controllable attenuator is formed to provide an attenuated signal, the level of which lies in a predetermined range, on the output side in spite of a variable level of a signal at the signal output of the amplifier.

9. The transmitter stage of claim 8, wherein the predetermined range is smaller than ±30% with reference to a predetermined nominal value.

10. The transmitter stage of claim 9, wherein the predetermined nominal value depends on a modulation characteristic of the analog/digital converter in the feedback branch.

11. The transmitter stage of claim 1, wherein the loop filter of the feed-forward branch is formed as digital filter and is arranged in the feed-forward branch upstream of the digital/analog converter in terms of signal flow.

12. The transmitter stage of claim 11, wherein the loop filter comprises adjustable filter coefficients, which are adjustable depending on a characteristic of the controllable oscillator, the power amplifier, or the transmission signal.

13. The transmitter stage of claim 1, wherein an analog anti-aliasing filter, which is formed so that an aliasing interference introduced by the digital/analog converter is at least partially suppressed, is arranged in the feed-forward branch between the digital/analog converter and the controllable oscillator in terms of signal flow.

14. The transmitter stage of claim 1, wherein the amplification controller comprises a variable gain amplifier, via the variable gain of which a power level of the signal at the signal output of the power amplifier can be adjusted.

15. The transmitter stage of claim 14, wherein the amplification controller further comprises a low-pass filter arranged downstream of the variable amplifier in terms of signal flow.

16. The transmitter stage of claim 14,
wherein the feedback branch comprises a controllable attenuator between the analog/digital converter and the diverter,
wherein the controllable attenuator is formed to provide an attenuated signal, the level of which lies in a predetermined range, on the output side in spite of a variable level of a signal at the signal output of the power amplifier, and
wherein further a level controller is provided, which is formed to increase attenuation of the controllable attenuator for the case of high amplification of the variable amplifier and reduce the attenuation of the controllable attenuator for the case of low amplification of the variable amplifier.

17. The transmitter stage of claim 1,
wherein a further digital/analog converter is provided in the amplification controller, so that an analog amplification control signal can be fed into the amplification control input of the power amplifier,
wherein the provider is formed to provide the amplitude representation in digital form.

18. The transmitter stage of claim 17, wherein an analog anti-aliasing filter, which is formed to at least partially suppress an aliasing interference introduced by the digital/analog converter, is arranged in signal flow direction downstream of the further digital/analog converter.

19. The transmitter stage of claim 16, wherein the controllable amplifier in the amplification controller is implemented as digital amplifier, the variable gain of which is controllable via a digital amplification control signal.

20. A transmitter stage for transmitting an amplitude and phase-modulated signal using a power amplifier with a signal input, a signal output, and an amplification control input, comprising:
a provider for providing an amplitude representation and a phase representation of the amplitude and phase-modulated signal;
a phase-locked loop with a feed-forward branch and a feedback branch,
wherein the feed-forward branch comprises a phase detector for comparing the phase representation as target signal with an actual signal to provide a tuning signal, a loop filter, and a controllable oscillator, which may be coupled to the signal input of the power amplifier,
wherein the feedback branch is coupled to a diverter for diverting a signal at the signal output of the power amplifier and comprises a determinator for determining the actual signal; and
an amplification controller formed to convert the amplitude representation to an amplification control signal, which may be fed into the amplification control input of the power amplifier,
wherein a digital/analog converter is provided in the amplification controller, so that an analog amplification control signal may be fed into the amplification control input of the power amplifier, and
wherein the provider is formed to provide the amplitude representation in digital form.

21. A method of transmitting an amplitude and phase-modulated signal using a power amplifier with a signal input, a signal output, and an amplification control input, comprising the steps of:
providing an amplitude representation and a phase representation of the amplitude and phase-modulated signal;
comparing the phase representation as target signal with a phase actual signal to obtain a tuning signal for a controllable oscillator, which may be coupled to the signal input of the power amplifier;
calculating the phase actual signal by diverting a signal at the signal output of the power amplifier and converting the diverted signal to the phase actual signal; and
determining an amplification control signal from the amplitude representation and feeding the amplification control signal into the amplification control input of the power amplifier,
wherein the step of determining the tuning signal comprises a step of digital/analog converting,
wherein the step of determining the actual signal comprises a step of analog/digital converting,
wherein, in the step of comparing, digital signals are compared, and
wherein, in the step of providing, the phase representation of the amplitude and phase-modulated signal is provided in digital form.

22. A computer program with a program code for performing, when the program is executed on a computer, the method of transmitting an amplitude and phase-modulated signal using a power amplifier with a signal input, a signal output, and an amplification control input, comprising the steps of:
providing an amplitude representation and a phase representation of the amplitude and phase-modulated signal;
comparing the phase representation as target signal with a phase actual signal to obtain a tuning signal for a controllable oscillator, which may be coupled to the signal input of the power amplifier;
calculating the phase actual signal by diverting a signal at the signal output of the power amplifier and converting the diverted signal to the phase actual signal; and
determining an amplification control signal from the amplitude representation and feeding the amplification control signal into the amplification control input of the power amplifier,
wherein the step of determining the tuning signal comprises a step of digital/analog converting,
wherein the step of determining the actual signal comprises a step of analog/digital converting,
wherein, in the step of comparing, digital signals are compared, and
wherein, in the step of providing, the phase representation of the amplitude and phase-modulated signal is provided in digital form.
